(19) United States
(12) Patent Application Publication
(10) Pub. No.: US 2010/0098985 A1
(43) Pub. Date: Apr. 22, 2010

(54) FUEL CELL AND ELECTRONIC DEVICE INCLUDING THE SAME

(75) Inventors: Tetsuro Kusamoto, Kanagawa (JP); Shuji Goto, Kanagawa (JP); Kazuaki Fukushima, Kanagawa (JP); Sayaka Nanjo, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/524,404

(22) PCT Filed: Feb. 1, 2008
(86) PCT No.: PCT/JP2008/051635

§ 371 Date: Jul. 24, 2009

(30) Foreign Application Priority Data
Feb. 5, 2007 (JP) 2007-025833

(51) Int. Cl. H01M 8/02

(52) U.S. Cl. 429/26; 429/12

(57) ABSTRACT

A small fuel cell capable of improving stability of power generation is provided. A heat insulating layer 40 is provided outside an oxidant-electrode-side package member 22. In a face 40A on an oxidant electrode 12 side of the heat insulating layer 40, temperature is increased by heat generation of the oxidant electrode 12. A face 40B on the opposite side of the face 40A is apart from the oxidant electrode 12 and the heat resistivity of the material is high, and accordingly the temperature thereof is lower than that of the face 40A on the oxidant electrode 12 side, and temperature difference is generated in the thickness direction of the heat insulating layer 40. Water generated in the oxidant electrode 12 is vaporized by heat generation of the oxidant electrode 12 and becomes water vapor. Heat is drawn as vaporization heat and thereby heat generation of a power generator 10 is suppressed. The generated water vapor is condensed by the temperature difference in the heat insulting layer 40. The water is vaporized again by heat generation of the power generator 10. Due to such a cycle, heat generation and moisture of the fuel cell 1A are appropriately controlled and stability of operation is improved. A water retaining layer is provided in a through hole 41, the water condensed in the heat insulating layer 40 is surely returned to the fuel cell 1A.

### TECHNICAL FIELD

The present invention relates to a fuel cell such as a Direct Methanol Fuel Cell (DMFC) in which methanol is directly supplied to a fuel electrode to initiate reaction, and an electronic device including the fuel cell.

### BACKGROUND ART

Currently, various primary batteries and secondary batteries are used as an electric source of electronic devices. One of indicators exhibiting characteristics of these batteries is an energy density. The energy density is an energy storage amount per unit mass of a battery.

As miniaturization and high performance of the electronic devices have been developed in recent years, a high capacity and a high output of the electric source, in particular, the high capacity of the electric source is increasingly necessitated. Thus, it has been difficult to supply a sufficient energy to drive the electronic devices with the use of the conventional primary batteries and the conventional secondary batteries. Therefore, it is urgently needed to develop a battery having a higher energy density. Fuel cells attract attention as one of candidates having a higher energy density.

The fuel cell has a structure in which an electrolyte is arranged between an anode (fuel electrode) and a cathode (oxidant electrode). A fuel is supplied to the fuel electrode, and air or oxygen is supplied to the oxidant electrode, respectively. As a result, redox reaction in which the fuel is oxidized by oxygen in the fuel electrode and the oxidant electrode is initiated, and part of chemical energy of the fuel is converted to electric energy and extracted.

Various types of fuel cells have been already proposed and experimentally produced, and part thereof is practically used. These fuel cells are categorized into an Alkaline Fuel Cell (AFC), a Phosphoric Acid Fuel Cell (PAFC), a Molten Carbonate Fuel Cell (MCFC), a Solid Electrolyte Fuel Cell (SOFC), a Polymer Electrolyte Fuel Cell (PEFC) and the like according to the electrolyte used. Of the foregoing fuel cells, the PEFC can be operated at lower temperature such as about from 30 deg C. to 130 deg C. both inclusive, compared to the other types of fuel cells.

As a fuel of the fuel cell, various flammable substances such as hydrogen and methanol can be used. However, a gas fuel such as hydrogen needs a storage cylinder or the like, and thus the gas fuel is not suitable for realizing a small-sized fuel cell. Meanwhile, a liquid fuel such as methanol has an advantage of being easily stored. Specially, the DMFC has an advantage that the DMFC does not need a reformer to extract hydrogen from the fuel, and accordingly the structure is simplified and a small-sized fuel cell can be thereby easily realized.

The energy density of methanol is theoretically 4.8 kW/L, which is 10 times or more the energy density of a general lithium ion secondary battery. That is, the fuel cell using methanol as a fuel has a high possibility to obtain a higher energy density than that of the lithium ion secondary battery. Further, since the fuel cells including the DMFC can be continuously used by supplying a fuel, the fuel cells have an advantage that charging time is not necessitated differently from the conventional secondary batteries. Furthermore, the fuel cells have a characteristic that harmful waste materials are not produced and thus the fuel cells are regarded as a clean battery.

From the above, among the various fuel cells, the PEFC, in particular, the DMFC is regarded as a most suitable electric source for electronic devices whose miniaturization and high performance have been developed, especially for small mobile electronic devices.

In the DMFC, in general, fuel methanol is supplied as a low-concentrated or a high-concentrated aqueous solution, or as pure methanol gas state to a fuel electrode. The supplied methanol is oxidized into carbon dioxide in a catalyst layer of the fuel electrode. Hydrogen ions (protons: H⁺) generated at this time are moved to an oxidant electrode through an electrolyte membrane that separates the fuel electrode from the oxidant electrode, and are reacted with oxygen in the oxidant electrode to generate water. The reactions initiated in the fuel electrode, the oxidant electrode, and the entire DMFC are expressed as Chemical formula 1.

Fuel electrode: CH₃OH+H₂O→CO₂+6e⁻+6H⁺

Oxidant electrode: (3/2)O₂+6e⁻+6H⁺→3H₂O

Entire DMFC: CH₃OH+(3/2)O₂→CO₂+2H₂O (Chemical Formula 1)

Water existing in the electrolyte membrane is largely responsible for hydrogen ion movement in the electrolyte membrane. It is known that as the amount of water contained in the electrolyte membrane is higher, hydrogen ions are more easily moved, that is, the ion conductivity is improved. Further, of energy released in reaction in the entire DMFC shown in the third expression in Chemical formula 1, part thereof is converted to electric energy, but the rest thereof is released as heat. Thus, it is known that power generation is accompanied with heat generation.

In the fuel cell, in the case where the cell temperature is increased by heat generation, the moisture of the electrolyte membrane is vaporized by heat and thus the moisture density is lowered and accordingly the ion conductivity of the electrolyte membrane is lowered. Thereby, the resistance of the cell is increased and further Joule heat is increased, and thus heat generation of the fuel cell is further promoted. To prevent such a negative cycle, it is important to realize stable power generation of the fuel cell.

To realize stable power generation of the DMFC, it is important to surely supplying methanol and air as a reacting substance and exhausting gas after reaction, and to appropriately control moisture and heat to stabilize operation of a membrane electrode assembly in which power generation is made.

Examples of conventional methods to stabilize methanol supply and air supply include a method to control a supply rate and a supply amount of methanol by using a pump or a blower. Examples of conventional methods to control moisture include a method to supply water together with a fuel to a fuel electrode, and a method to prevent accumulated water on an oxidant electrode by arranging a blower on the oxidant electrode side. Examples of conventional methods to stabilize temperature by controlling heat generated in a cell include a method to use a heat exchanger and a method to provide a chiller with the use of a radiation fin.

### [Patent Document 1] Japanese Unexamined Patent Application Publication No. 9-245800

### DISCLOSURE OF INVENTION

In mounting a DMFC on an electronic device, however, an auxiliary part to support stabilization of power generation such as the blower and the radiation fin described above hinders miniaturization of the fuel cell, and impairs the advantage of the fuel cell of the high energy density. In particular, in the case where a small DMFC to be mounted on a small electronic device is fabricated, it is necessary to use a method to stabilize power generation without using such an auxiliary part as much as possible.

Examples of methods to control moisture and heat of the fuel cell and to stabilize power generation without using the auxiliary part include a method to retain water generated in power generation of the fuel cell in the system, that is, a method to retain water in the fuel cell. For example, in Patent Document 1, as illustrated in FIG. 10, a structure in which water repellent sections 212A and 212B are respectively provided on the electrolyte membrane side of an oxidant electrode 212 and on the oxidant gas flow path side of the oxidant electrode 212 is disclosed.

However, in the structure described in Patent Document 1, water generated in the oxidant electrode 212 is repelled by the water repellent section 212A. Thus, though water is necessary for reaction in the fuel electrode as shown in the first expression of Chemical formula 1, necessary water is not able to be moved to the fuel electrode.

In view of the foregoing problems, it is an object of the present invention to provide a small fuel cell capable of improving stability of power generation and an electronic device using the same.

A first fuel cell according to the present invention contains a power generator in which a fuel electrode and an oxidant electrode are oppositely arranged with an electrolyte in between, between a fuel-electrode-side package member and an oxidant-electrode-side package member. A heat insulating layer is included in at least one of a location between the oxidant-electrode-side package member and the oxidant electrode and a location outside the oxidant-electrode-side package member. “Outside the oxidant-electrode-side package member” herein means a side located on the opposite side of the oxidant-electrode-side package member from the power generator (oxidant introduction side).

A second fuel cell according to the present invention contains a power generator in which a fuel electrode and an oxidant electrode are oppositely arranged with an electrolyte in between, between a fuel-electrode-side package member and an oxidant-electrode-side package member. The oxidant-electrode-side package member is made of a material having heat insulating properties.

In the first fuel cell of the present invention or the second fuel cell of the present invention, in a face on the oxidant electrode side of the heat insulating layer or the oxidant-electrode-side package member, temperature is increased by power generation of the oxidant electrode. Meanwhile, a face on the opposite side of the face on the oxidant electrode side is apart from the oxidant electrode and the heat resistivity of the material is high, and accordingly the temperature thereof is lower than that of the face on the oxidant electrode side. Thereby, temperature difference (temperature gradient) is formed in the thickness direction of the heat insulating layer or the oxidant-electrode-side package member. Water generated in the oxidant electrode is vaporized by heat generation of the oxidant electrode and becomes water vapor. At this time, heat is drawn as vaporization heat and thereby heat generation of the power generator is suppressed. The generated water vapor is cooled and condensed by the temperature difference in the heat insulting layer or the oxidant-electrode-side package member, and is returned to the oxidant electrode. The water is vaporized again by heat generation of the power generator. At this time, heat is drawn as vaporization heat and thereby heat generation of the power generator is suppressed. Due to such a cycle, heat generation and moisture of the fuel cell are appropriately controlled and stability of operation is improved.

Further, the foregoing heat insulting layer or the foregoing oxidant-electrode-side package member is arranged on the oxidant electrode side of the electrolyte and in a location outside the oxidant electrode (specifically, current collector of the oxidant electrode), and the conventional water repellent section is not provided on the electrolyte side of the oxidant electrode. Thus, the condensed water is moved through the electrolyte to the fuel electrode without being blocked by the water repellent section, and can contribute to reaction.

A first electronic device and a second electronic device of the present invention include a fuel cell containing a power generator in which a fuel electrode and an oxidant electrode are oppositely arranged with an electrolyte in between, between a fuel-electrode-side package member and an oxidant-electrode-side package member. The fuel cells are respectively composed of the foregoing first and the foregoing second fuel cells of the present invention.

In the first electronic device of the present invention or the second electronic device of the present invention, the foregoing first or the foregoing second fuel cell of the present invention is respectively included. Thus, though the fuel cell is small, stability of power generation is high. Therefore, the fuel cell is significantly advantageous to miniaturization of an electronic device.

According to the first fuel cell of the present invention, the heat insulating layer is provided in at least one of the location between the oxidant-electrode-side package member and the oxidant electrode and the location outside the oxidant-electrode-side package member. Further according to the second fuel cell of the present invention, the oxidant-electrode-side package member is made of the material having heat insulating properties. Thus, differently from the conventional art, a significantly small structure not necessitating an auxiliary part such as a blower and a radiation fin can be realized. In addition, heat generation and moisture are appropriately controlled and stability of power generation can be improved. Further, differently from the conventional art, it is not necessary to supply water together with a fuel to the fuel electrode, and to actively supply water to the electrolyte membrane. Accordingly, in the case where the fuel cell is mounted on an electronic device, the electronic device can be significantly miniaturized while taking advantages of the stable power generation and the high energy efficiency of the fuel cell.

### BRIEF DESCRIPTION OF DRAWINGS

FIG. 1 is a view illustrating a schematic structure of an electronic device including a fuel cell according to a first embodiment of the present invention.

FIG. 2 is a perspective view illustrating an example of the heat insulating layer illustrated in FIG. 1.

FIG. 3 is a perspective view illustrating another example of the heat insulating layer illustrated in FIG. 1.

FIG. 4 is a perspective view illustrating a manufacturing process of the heat insulating layer illustrated in FIG. 2.

FIG. 5 is a perspective view illustrating a manufacturing process of the heat insulating layer illustrated in FIG. 3.

FIG. 6 is a view illustrating a schematic configuration of an electronic device including a fuel cell according to a second embodiment of the present invention.

FIG. 7 is a view illustrating a schematic configuration of an electronic device including a fuel cell according to a third embodiment of the present invention.

FIG. 8 is a view illustrating a structure of a fuel cell according to a comparative example.

FIG. 9 is a view illustrating a modified example of the fuel cell illustrated in FIG. 1 and FIG. 6.

FIG. 10 is a view illustrating a structure of a conventional oxidant electrode.

### BEST MODE(S) FOR CARRYING OUT THE INVENTION

Embodiments of the present invention will be hereinafter described in detail.

### First Embodiment

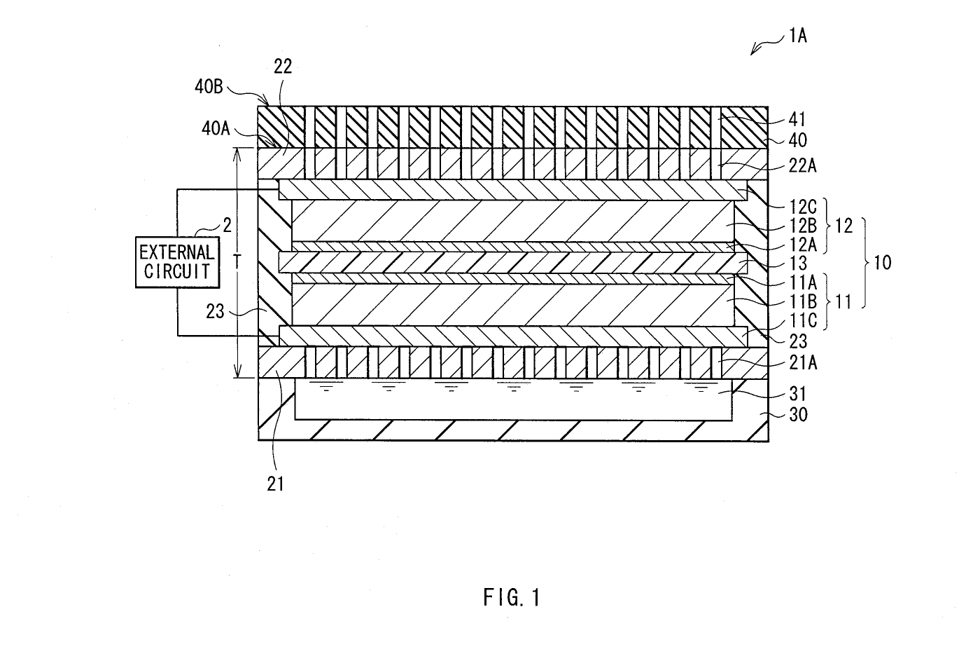

FIG. 1 illustrates a schematic configuration of an electronic device having a fuel cell according to a first embodiment of the present invention. The electronic device is, for example, a mobile device such as a mobile phone and a Personal Digital Assistant (PDA) or a notebook Personal Computer (PC). The electronic device includes a fuel cell 1A and an external circuit (load) 2 driven by electric energy generated by the fuel cell 1A.

The fuel cell 1A is a so-called Direct Methanol Fuel Cell (DMFC). The fuel cell 1A has a power generator (membrane electrode assembly) 10 in which a fuel electrode (anode) 11 and an oxidant electrode (cathode) 12 are oppositely arranged with an electrolyte membrane 13 in between. The power generator 10 is contained between a fuel-electrode-side package member 21 and an oxidant-electrode-side package member 22, and the side face thereof is sealed by a side face package member 23. Outside the fuel-electrode-side package member 21, a fuel chamber 30 is provided.

The fuel electrode 11 has a laminated structure in which a catalyst layer 11A, a gas diffusion layer 11B, and a fuel electrode current collector 11C are sequentially layered from the oxidant electrode 12 side, and is covered with the fuel-electrode-side package member 21. A fuel 31 is supplied from the fuel chamber 30 to the fuel electrode 11 through the fuel-electrode-side package member 21.

The oxidant electrode 12 has a laminated structure in which a catalyst layer 12A, a gas diffusion layer 12B, and an oxidant electrode current collector 12C are sequentially layered from the fuel electrode 11 side, and is covered with the oxidant-electrode-side package member 22. In addition, air, oxygen, or gas containing oxygen is supplied to the oxidant electrode 12 through the oxidant-electrode-side package member 22.

The catalyst layers 11A and 12A are composed of a simple substance or an alloy of a metal such as palladium (Pd), platinum (Pt), iridium (Ir), rhodium (Rh), and ruthenium (Ru) as a catalyst. The gas diffusion layers 11B and 12B are made of, for example, a carbon cloth, a carbon paper, or a carbon sheet. The fuel electrode current collector 11C and the oxidant electrode current collector 12C are made of, for example, a carbon cloth composed of, for example, carbon fiber.

The electrolyte membrane 13 is made of, for example, a polyperfluoroalkyl sulfonic acid-based resin (“Nafion (registered trademark),” produced by Du Pont) or other resin having proton conductivity.

The fuel-electrode-side package member 21, the oxidant-electrode-side package member 22, and the side face package member 23 configure a housing that contains the fuel cell 1A. The fuel-electrode-side package member 21, the oxidant-electrode-side package member 22, and the side face package member 23 are, for example, about 1 mm thick, and are made of a metal such as aluminum (Al), iron (Fe), and stainless steel; a hydrocarbon system polymer material such as polypropylene; or a polymer material containing fluorine such as polytetrafluoroethylene. The metal material has features that the metal material has low heat resistivity and has electron conductivity though the hardness is higher than that of the polymer material. Further, some metal materials have a susceptibility to acid and alkali. Meanwhile, the polymer material has insulation properties, and the polymer material containing fluorine has high acid resistance, high alkali resistance, and high heat resistivity. However, the polymer material has low hardness and lower melting point than that of the metal material. The component materials of the fuel-electrode-side package member 21, the oxidant-electrode-side package member 22, and the side face package member 23 should be appropriately selected according to environment to which the fuel cell 1A is introduced. For example, in the case where the fuel cell 1A is introduced to a mobile phone as an electronic device, if the metal material is selected as a component material of the fuel-electrode-side package member 21, the oxidant-electrode-side package member 22, and the side face package member 23, heat generated in power generation is easily conducted outside through the fuel-electrode-side package member 21, the oxidant-electrode-side package member 22, and the side face package member 23, the heat is conducted to a device existing at the periphery of the fuel cell 1A, and operation of the device might be thereby unstable. In such a case, as a component material of the fuel-electrode-side package member 21, the oxidant-electrode-side package member 22, and the side face package member 23, a material having high heat resistivity such as the hydrocarbon system polymer material such as polypropylene is regarded as a suitable material.

The fuel-electrode-side package member 21 and the oxidant-electrode-side package member 22 are respectively provided with through holes 21A and 22A for supplying the fuel 31 or air. The through holes 21A and 22A penetrate from the surface on the power generator 10 side of the fuel-electrode-side package member 21 and the oxidant-electrode-side package member 22 to the surface on the fuel introduction side or the air introduction side of the fuel-electrode-side package member 21 and the oxidant-electrode-side package member 22. According to the shape and the size of through holes 21A and 22A, the supply amount and the diffusivity of the fuel 31 or air can be changed. Further, the fuel-electrode-side package member 21 and the oxidant-electrode-side package member 22 also have a function as a pressure plate to the power generator 10. According to the shape and the size of the through holes 21A and 22A, distribution in a plane direction of the pressure applied to the power generator 10 can be changed as well.

The fuel chamber 30 is composed of, for example, a tank or a cartridge made of a material similar to that of the fuel-electrode-side package member 21, the oxidant-electrode-side package member 22, and the side face package member 23. As the fuel 31, 100% methanol may be supplied, or 100% methanol may be supplied as an aqueous solution thereof. Further, it is possible that a fuel support (not illustrated) such as a sponge is arranged in the fuel chamber 30, the fuel 31 is absorbed into the fuel support, and the fuel 31 is naturally vaporized, and thereby the fuel 31 is supplied to the fuel electrode 11 not as a liquid but as a gas. Thereby, a pump for actively supplying the fuel 31 to the fuel electrode 11 is able to be unnecessary. In addition, to block heat conduction to the fuel 31, it is desirable that the fuel chamber 30 be, for example, about 1 mm thick, and be made of a material having high heat resistivity, for example, a polymer material such as polypropylene. If heat is conducted to the fuel 31, vaporization is promoted, and thus there is a possibility that the fuel 31 is excessively supplied to the power generator 10.

The fuel cell 1A has a heat insulating layer 40 outside the oxidant-electrode-side package member 22. Thereby, in the fuel cell 1A, stability of power generation can be improved with the simple structure.

The heat insulating layer 40 is made of a plastic such as polyethylene, polystyrene, an acryl resin, polycarbonate, and polytetrafluoroethylene; rubber such as urethane rubber, silicone rubber, and fluorine rubber; glass; silicon carbide; silicon nitride; amorphous carbon; porous ceramics; wood, cork; paper; or ceramics. Two or more thereof may be used by mixture. The component material of the heat insulating layer 40 is desirably selected according to necessary physicality such as strength and heat insulating properties, and convenience such as workability. For example, the component material of the heat insulating layer 40 is preferably a material, for example, having heat conductivity of 0.4 W/(m·K) or less, since thereby a sufficient temperature difference (temperature gradient) as will be described later can be formed in the heat insulating layer 40.

Further, to take advantage of the high energy density of the fuel cell 1A, it is desirable that the heat insulating layer 40 have a small cubic volume and a small thickness as much as possible. In particular, in the case where the fuel cell is mounted on a small electronic device, the thickness of the heat insulating layer 40 is preferably 5 mm or less, for example, about 2 mm. Further, it is more preferable that the thickness of the heat insulating layer 40 is equal to or less than twice a total thickness T from the surface on the air introduction side of the oxidant-electrode-side package member 22 to the surface on the fuel introduction side of the fuel-electrode-side package member 21.

The heat insulating layer 40 is provided with a through hole 41 for supplying air. The through hole 41 penetrates from the surface on the power generator 10 side of the heat insulating layer 40 to the surface on the air introduction side, and is in communicated with the through hole 22A of the oxidant-electrode-side package member 22. According to the shape and the size of the through hole 41, the supply amount and the diffusivity of air can be changed. Thereby, a pump for actively supplying air to the oxidant electrode 12 is able to be unnecessary. It is possible that instead of the through hole 41, the heat insulating layer 40 be made of a porous material such as porous ceramics and foamed plastic, and thereby air path is formed. In this case, to prevent moisture vapor from getting out of the side face of the heat insulating layer 40, it is desirable that the side face of the heat insulating layer 40 be hermetically sealed by a sealing material (not illustrated) or the side face package member 23.

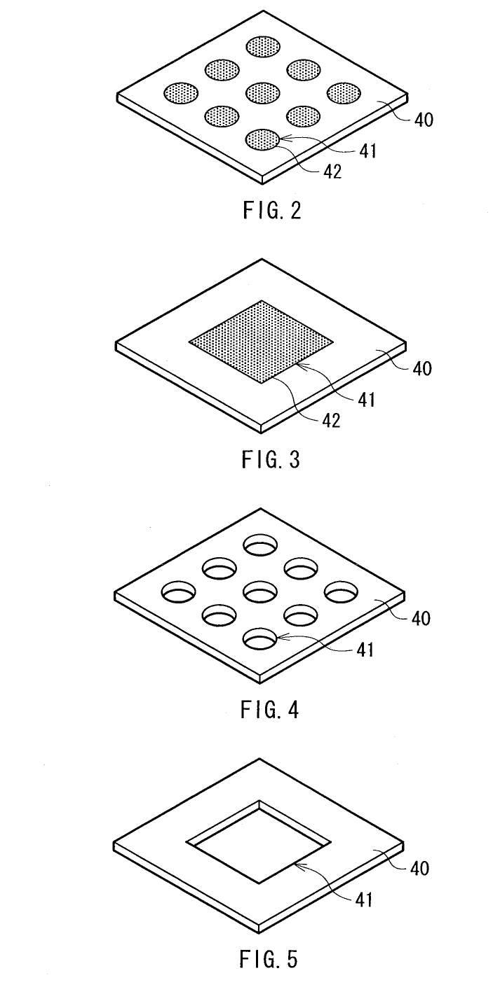

FIG. 2 and FIG. 3 illustrate a structure example of the heat insulating layer 40 having such a through hole 41. The through hole 41 may be small holes isotropically distributed in the heat insulating layer 40 as illustrated in FIG. 1 and FIG. 2, or may be an aperture provided in a center of the heat insulating layer 40 in the shape of a frame as illustrated in FIG. 3

A water retaining layer 42 is preferably provided in the through hole 41. Higher water retentivity can be thereby obtained. The water retaining layer 42 does not allow water to pass through, but has aeration property. The water retaining layer 42 is preferably made of a material having water retentivity, water repellency, or hydrophilicity, and combination thereof. Specific examples thereof include a membrane having a main component of a hydrocarbon system polymer material such as foamed polyethylene or a fluorine-containing system polymer material. Further, the water retaining layer 42 is preferably made of a material having high heat resistivity. Thereby, it is possible to prevent heat from being conducted to the heat insulating layer 40 through the water retaining layer 42, and after-mentioned sufficient temperature difference (temperature gradient) is formed in the heat insulating layer 40. It is enough that the thickness of the water retaining layer 42 is equal to or less than the thickness of the heat insulating layer 40. For example, in the case where the thickness of the heat insulating layer 40 is 2 mm, the thickness of the water retaining layer 42 is able to be about 1 mm.

An electronic device including the fuel cell 1A can be manufactured, for example, as follows.

First, a catalyst made of an alloy containing, for example, platinum (Pt) and ruthenium (Ru) at a predetermined ratio is formed. The gas diffusion layer 11B made of the foregoing material is coated with the catalyst, and thereby the catalyst layer 11A is formed. In addition, the catalyst can be formed by injecting hydrogen gas into an aqueous solution containing, for example, chloroplatinic acid and ruthenium chloride. Next, the fuel electrode current collector 11C made of the foregoing material is thermocompression-bonded to the gas diffusion layer 11B, and the fuel electrode 11 is thereby formed.

Further, a catalyst made of, for example, platinum (Pt) is formed. The gas diffusion layer 12B made of the foregoing material is coated with the catalyst, and thereby the catalyst layer 12A is formed. In addition, the catalyst can be formed by injecting hydrogen gas into an aqueous solution containing, for example, chloroplatinic acid. Next, the oxidant electrode current collector 12C made of the foregoing material is thermocompression-bonded to the gas diffusion layer 12B, and the oxidant electrode 12 is thereby formed.

Subsequently, the electrolyte membrane 13 made of the foregoing material is sandwiched between the fuel electrode 11 and the oxidant electrode 12. Each layer is jointed by thermocompression bonding, for example, under a pressure of 150 kg/cm², at 150 deg C. for 5 minutes, and thereby the power generator 10 is formed.

After that, the fuel-electrode-side package member 21 and the oxidant-electrode-side package member 22 that have, for example, the foregoing thickness and are made of the foregoing material are prepared. The through holes 21A and 22A are provided by physical machining by using, for example, a drill or the like. After that, the power generator 10 is contained between the fuel-electrode-side package member 21 and the oxidant-electrode-side package member 22.

After the power generator 10 is contained between the fuel-electrode-side package member 21 and the oxidant-electrode-side package member 22, the heat insulating layer 40 that has, for example, the foregoing thickness and is made of the foregoing material is prepared. The heat insulating layer 40 is attached to outside of the oxidant-electrode-side package member 22. At this time, as illustrated in FIG. 4 or FIG. 5, the through hole 41 is provided by physical machining by using, for example, a drill or the like. A material that has, for example, an outer diameter similar to that of the through hole 41 and has water retention ability is provided in the through hole 41. Accordingly, the water retaining layer 42 that has, for example, the foregoing thickness and is made of the foregoing material is formed.

After the heat insulating layer 40 is provided outside the oxidant-electrode-side package member 22, the side face package member 23 that has, for example, the foregoing thickness and is made of the foregoing material is prepared, and the side face of the power generator 10 is sealed by the side face package member 23.

After the side face of the power generator 10 is sealed, the fuel chamber 30 that has, for example, the foregoing thickness and is made of the foregoing material is prepared. A sponge (not illustrated) into which, for example, 100% methanol is absorbed as the fuel 31 is arranged in the fuel chamber 30. The fuel chamber 30 is attached to outside of the fuel-electrode-side package member 21. The fuel cell 1A illustrated in FIG. 1 is thereby formed. The external circuit 2 is connected to the fuel cell 1A, and thereby the electronic device illustrated in FIG. 1 is completed.

In the electronic device including the fuel cell 1A, the fuel 31 is supplied to the fuel electrode 11 of the fuel cell 1A, and reaction is initiated to generate a proton and an electron. The proton is moved through the electrolyte membrane 13 to the oxidant electrode 12, and then is reacted with an electron and oxygen to generate water. Thereby, part of the chemical energy of methanol as the fuel 31 is converted to electric energy, a current is extracted from the fuel cell 1A, and the external circuit 2 is driven. In this embodiment, the heat insulating layer 40 is provided outside the oxidant-electrode-side package member 22. Thus, in a face 40A on the oxidant electrode 12 side of the heat insulating layer 40, the temperature is increased by heat generation of the oxidant electrode 12. Meanwhile, a face 40B on the opposite side of the face 40A is apart from the oxidant electrode 12 and the heat resistivity of the material is high, and accordingly the temperature thereof is lower than that of the face 40A on the oxidant electrode 12 side. Thereby, temperature difference (temperature gradient) is formed in the thickness direction of the heat insulating layer 40. The water generated in the oxidant electrode 12 is vaporized by heat generation of the oxidant electrode 12 and becomes water vapor. At this time, heat is drawn as vaporization heat and thereby heat generation of the power generator 10 is suppressed. The generated water vapor is cooled by the temperature difference in the heat insulting layer 40, is condensed, and is returned to the oxidant electrode 12. The water is vaporized again by heat generation of the power generator 10. At this time, heat is drawn as vaporization heat and thereby heat generation of the power generator 10 is suppressed. Such a cycle is formed, and thereby heat generation and moisture of the fuel cell 1A are appropriately controlled and stability of operation is improved.

Further, since the water retaining layer 42 is provided in the through hole 41 of the heat insulating layer 40, the water cooled and condensed in the heat insulating layer 40 is surely returned to the fuel cell 1A.

Further, such a heat insulating layer 40 is arranged in a location outside the oxidant electrode current collector 12C, and the conventional water repellent section is not provided on the electrolyte membrane 13 side of the oxidant electrode 12. Thus, the condensed water is not blocked by the water repellent section and is moved through the electrolyte membrane 13 to the fuel electrode 11, and can contribute to reaction.

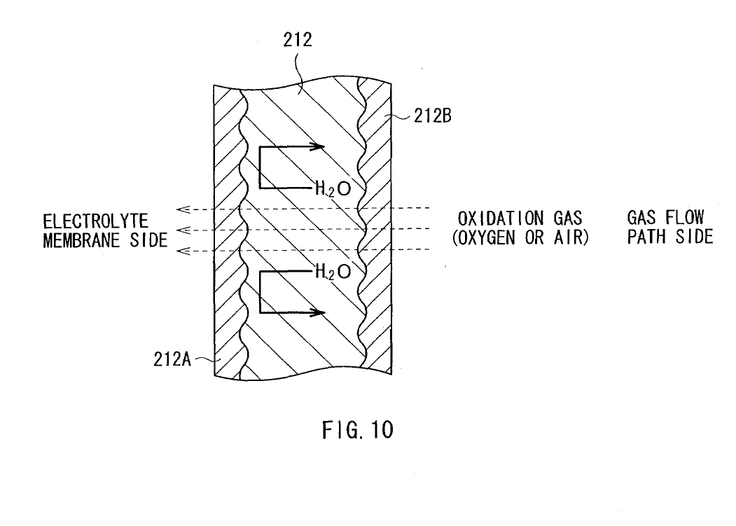

Meanwhile, in the conventional art, as illustrated in FIG. 10, the water repellent sections 212A and 212B are respectively provided on the electrolyte membrane side and on the oxidation gas flow path side of the oxidant electrode 212. Thus, in the power generation, the temperature of the oxidant electrode 212 may be high, most of water becomes gas, and there is a possibility that water retention function of the water repellent sections 212A and 212B is not sufficiently demonstrated. Further, the water repellent sections 212A and 212B work as resistance where loss of a voltage and further loss of electric energy are generated. Such a loss of electric energy becomes Joule heat, that is, heat, and causes unstable power generation of the fuel cell. In addition, since the water repellent sections 212A and 212B are provided on the both sides of the oxidant electrode 212, electric conductivity as an electrode and gas diffusivity deteriorate, leading to deterioration of energy efficiency.

As described above, in this embodiment, since the heat insulating layer 40 is provided outside the oxidant-electrode-side package member 22, heat generation and moisture can be appropriately controlled and stability of power operation can be improved by a significantly small structure not necessitating an auxiliary part such as a radiation fin. Further, a blower that actively or automatically wastes heat to regions other than the fuel cell 1A is not necessitated. It is not necessary to supply water together with the fuel 31 to the fuel electrode 11, or to actively supply water to the electrolyte membrane 13. Thus, in the case where an electronic device is configured by connecting the fuel cell 1A to the external circuit 2, a small electronic device taking advantages of the stable power generation and the high energy efficiency of the fuel cell 1A can be realized.

### Second Embodiment

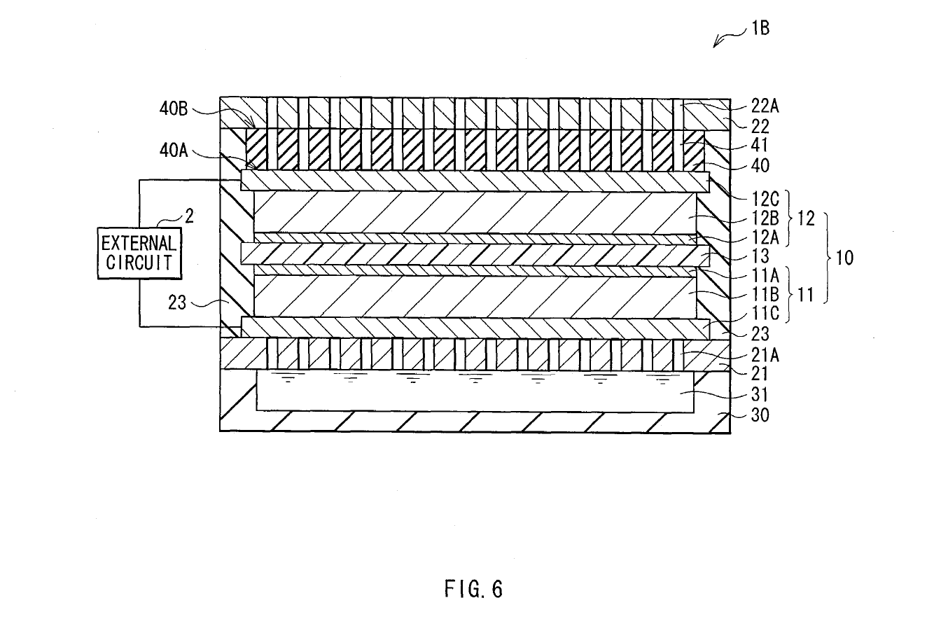

FIG. 6 illustrates a structure of a fuel cell 1B according to a second embodiment of the present invention. The fuel cell 1B has the same structure and the same action as those of the fuel cell 1A described in the first embodiment, except that the heat insulating layer 40 is arranged between the oxidant-electrode-side package member 22 and the oxidant electrode 12, specifically between the oxidant-electrode-side package member 22 and the oxidant current collector 12C, and can be manufactured in the same manner as that of the fuel cell 1A.

In this embodiment, the heat insulating layer 40 is provided between the oxidant-electrode-side package member 22 and the oxidant electrode 12, specifically between the oxidant-electrode-side package member 22 and the oxidant current collector 12C. Thus, in addition to the effect of the first embodiment, the heat insulating layer 40 is not exposed, the oxidant-electrode-side package member 22 having relatively high strength can be arranged outermost, and the strength of the fuel cell 1B can be improved.

### Third Embodiment

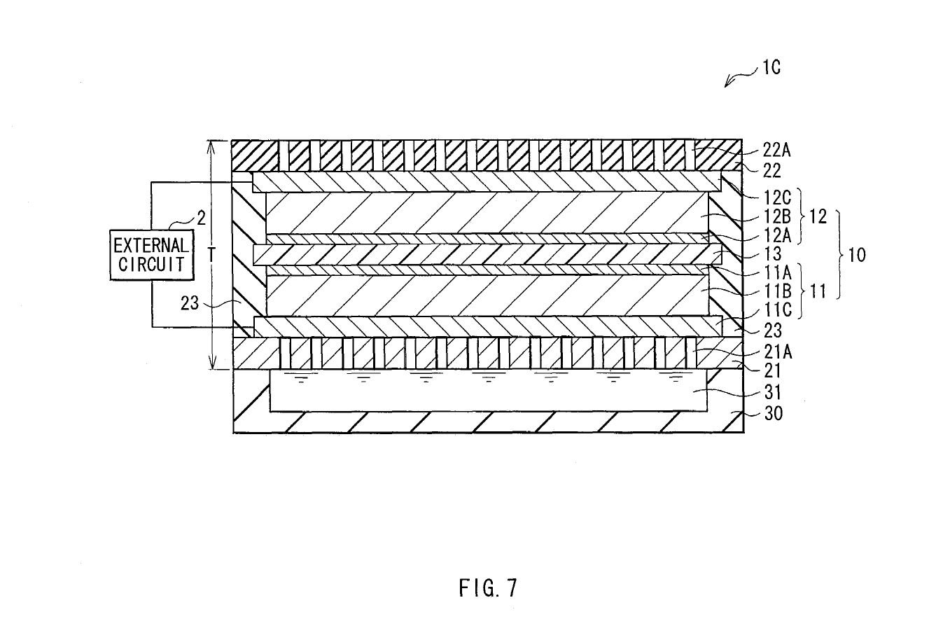

FIG. 7 illustrates a structure of a fuel cell 1C according to a third embodiment of the present invention. The fuel cell 1C has the same structure as that of the fuel cell 1A described in the first embodiment, except that the heat insulating layer 40 is not provided and the oxidant-electrode-side package member 22 is made of a material having heat insulating properties. Therefore, a description will be given by using the same referential symbols for the corresponding elements.

A component material of the oxidant-electrode-side package member 22 is preferably a material with which pressure resistance and insulation properties can be realized that is selected from the component materials of the heat insulating layer 40 described in the first and the second embodiments. To prevent electric energy generated in the power generator 10 from being leaked outside through the oxidant-electrode-side package member 22, the insulation properties are necessitated. Specifically, the oxidant-electrode-side package member 22 is made of a plastic such as polyethylene, polystyrene, an acryl resin, polycarbonate, and polytetrafluoroethylene; rubber such as urethane rubber, silicone rubber, and fluorine rubber; glass; silicon carbide; silicon nitride; porous ceramics; wood; cork; paper; or ceramics. Two or more thereof may be used by mixture. The component material of the oxidant-electrode-side package member 22 is preferably a material having, for example, heat conductivity of 0.4 W/(m·K) or less as in the first embodiment, since thereby a sufficient temperature difference (temperature gradient) can be formed in the oxidant-electrode-side package member 22.

Further, the thickness of the oxidant-electrode-side package member 22 is preferably 5 mm or less as in the first embodiment. Further, it is more preferable that the thickness of the oxidant-electrode-side package member 22 be equal to or less than two thirds of the total thickness T from the surface on the air introduction side of the oxidant side package member 22 to the surface on the fuel introduction side of the fuel-electrode-side package member 21.

The water retaining layer 42 is preferably provided in the through hole 22A of the oxidant-electrode-side package member 22 as in the first embodiment. Higher water retentivity is thereby obtained.

The fuel cell 1C can be manufactured in the same manner as that of the first embodiment, except that the heat insulating layer 40 is not provided, the oxidant-electrode-side package member 22 is made of the foregoing material having insulation properties, and the water retaining layer 42 is provided in the through hole 22A.

In an electronic device including the fuel cell 1C, a current is extracted from the fuel cell 1C, and the external circuit 2 is driven as in the first embodiment. In this embodiment, the oxidant-electrode-side package member 22 is made of the material having heat insulating properties. Thus, temperature difference (temperature gradient) similar to that of the heat insulating layer 40 of the first embodiment is formed in the thickness direction of the oxidant-electrode-side package member 22. The water generated in the oxidant electrode 12 is vaporized by heat generation of the oxidant electrode 12 and becomes water vapor. At this time, heat is drawn as vaporization heat and thereby heat generation of the power generator 10 is suppressed. The generated water vapor is cooled by the temperature difference in the oxidant-electrode-side package member 22, is condensed, and is returned to the oxidant electrode 12. The water is vaporized again by heat generation of the power generator 10. At this time, heat is drawn as vaporization heat and thereby heat generation of the power generator 10 is suppressed. Such a cycle is formed, and thereby heat generation and moisture of the fuel cell 1C are appropriately controlled and stability of operation is improved.

Further, since the water retaining layer 42 is provided in the through hole 22A of the oxidant-electrode-side package member 22, the water cooled and condensed in the oxidant-electrode-side package member 22 is surely returned to the fuel cell 1C.

As described above, in this embodiment, since the oxidant-electrode-side package member 22 is made of the material having heat insulating properties, heat generation and moisture are appropriately controlled and stability of power operation is improved with the significantly simple structure as in the first embodiment. Accordingly, the fuel cell of this embodiment is suitably used for realizing miniaturization of an electronic device.

### Example

Further, a description will be given of a specific example of the present invention. In addition, in the following example, the fuel cell 1A having a structure similar to that of FIG. 1 was fabricated, and the characteristics were evaluated. Therefore, for the following example, a description will be given by using the same referential symbols with reference to FIG. 1 as well.

The fuel cell 1A having a structure similar to that of FIG. 1 was fabricated. First, a catalyst made of an alloy containing platinum (Pt) and ruthenium (Ru) at a predetermined ratio was formed by injecting hydrogen gas into an aqueous solution containing chloroplatinic acid and ruthenium chloride. The gas diffusion layer 11B made of a carbon cloth was coated with the catalyst, and thereby the catalyst layer 11A was formed. Next, the fuel electrode current collector 11C made of a carbon cloth composed of carbon fiber (plain cloth, GF-20-P7, produced by Nippon Carbon Co., Ltd.) was thermocompression-bonded to the gas diffusion layer 11B, and the fuel electrode 11 being 2×2 cm² in size was thereby formed.

Further, a catalyst made of platinum (Pt) was formed by injecting hydrogen gas into an aqueous solution containing chloroplatinic acid. The gas diffusion layer 12B made of a carbon cloth was coated with the catalyst, and thereby the catalyst layer 12A was formed. Next, the oxidant electrode current collector 12C made of a carbon cloth similar to that of the fuel electrode current collector 11C was thermocompression-bonded to the gas diffusion layer 12B, and the oxidant electrode 12 being 2×2 cm² in size was thereby formed.

Subsequently, the electrolyte membrane 13 made of a polyperfluoroalkyl sulfonic acid-based resin (“Nafion (registered trademark),” produced by Du Pont) was sandwiched between the fuel electrode 11 and the oxidant electrode 12. Each layer was jointed by thermocompression bonding under a pressure of 150 kg/cm², at 150 deg C. for 5 minutes. Accordingly, the power generator 10 was formed.

After that, the fuel-electrode-side package member 21 and the oxidant-electrode-side package member 22 made of a stainless steel plate being 1 mm thick were prepared. The through holes 21A and 22A were provided by using a drill. After that, the power generator 10 was contained between the fuel-electrode-side package member 21 and the oxidant-electrode-side package member 22.

After the power generator 10 was contained between the fuel-electrode-side package member 21 and the oxidant-electrode-side package member 22, the heat insulating layer 40 made of polytetrafluoroethylene being 2 mm thick was prepared. The heat insulating layer 40 was attached to outside of the oxidant-electrode-side package member 22. At that time, as illustrated in FIG. 5, the through hole 41 was provided by using a drill, and the water retaining layer 42 made of a foamed polyethylene film being 1 mm thick that was shaped into an outer shape similar to that of the through hole 41 was provided in the through hole 41.

After the heat insulating layer 40 was provided outside the oxidant-electrode-side package member 22, the side face package member 23 made of polypropylene being 1 mm thick was prepared, and the side face of the power generator 10 was sealed by the side face package member 23.

After the side face of the power generator 10 was sealed, the fuel chamber 30 made of polypropylene being 1 mm thick was prepared. A sponge (not illustrated) into which 0.2 ml of 100% methanol was absorbed as the fuel 31 was arranged in the fuel chamber 30. The fuel chamber 30 was attached to outside of the fuel-electrode-side package member 21. The fuel cell 1A illustrated in FIG. 1 was thereby completed.

As Comparative example 1 relative to this example, a fuel cell was fabricated in the same manner as that of this example, except that an aluminum (Al) plate being 2 mm thick was provided instead of the heat insulating layer 40.

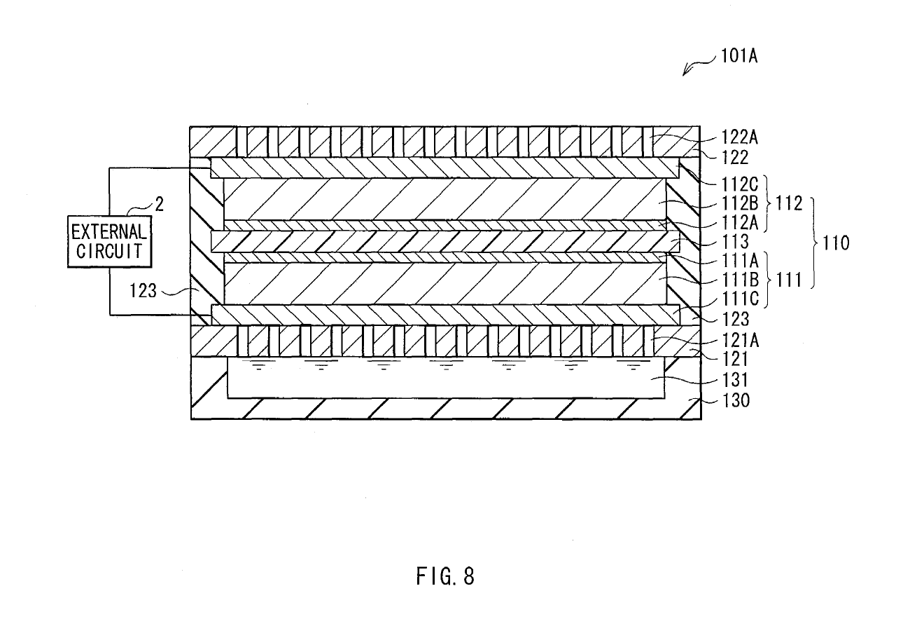

Further, as Comparative example 2, as illustrated in FIG. 8, a fuel cell 101A was fabricated in the same manner as that of this example, except that neither the heat insulating layer nor the aluminum plate were provided. In addition, in the fuel cell 101A illustrated in FIG. 8, for the same elements as those of the fuel cell 1A, the referential symbols written with three digits that are obtained by adding 100 to the referential symbols of the fuel cell 1A are used.

For the obtained fuel cells 1A and 101A of Example and Comparative examples 1 and 2, the power generation characteristics were evaluated. Power generation was made under a constant current of 300 mA, and was finished when the cell voltage became 0 V. When 15 minutes lapsed after starting power generation, temperature (temperature A) of the oxygen introduction side surface of the oxidant-electrode-side package members 22 and 122, temperature (temperature B) of the oxygen introduction side surface of the heat insulating layer 40 or the aluminum plate, cell resistance measured by current cutoff method, and power generation time and average output of each fuel cell were examined. The results are shown in Table 1 and Table 2.

TABLE 1

| | Heat | | Water | | | Resistance |
|---|---|---|---|---|---|---|
| | insulating | | retaining | Temperature | Temperature | value of |
| | layer | Al plate | layer | A (deg C.) | B (deg C.) | cell (mΩ) |
| Example | Present | Not | Present | 48.2 | 38.0 | 212.3 |
| | | present | | | | |
| Comparative | Not | Present | Present | 47.1 | 45.6 | 262.2 |
| example 1 | present | | | | | |
| Comparative | Not | Not | Not | 53.7 | — | 298.5 |
| example 2 | present | present | present | | | |

TABLE 2

| | Heat | | Water | Power | Average |
|---|---|---|---|---|---|
| | insulating | | retaining | generation | output |
| | layer | Al plate | layer | time (min) | (mW/cm²) |
| Example | Present | Not | Present | 55.6 | 50.8 |
| | | present | | | |
| Comparative | Not | Present | Present | 28.2 | 34.0 |
| example 1 | present | | | | |
| Comparative | Not | Not | Not | 20.3 | 26.2 |
| example 2 | present | present | present | | |

When a comparison was made between Example 1 and Comparative example 2, as evidenced by Table 1, in Example 1 in which the heat insulating layer 40 was provided, the cell resistance was lower than that of Comparative example 2 in which the heat insulating layer was not provided. It showed that in Example, by introducing the heat insulting layer 40 and the water retaining layer 42 in the through hole 41, water is retained in the fuel cell 1A, and the ion conductivity in the power generator 10 was higher than that of Comparative example 2. The same is evidenced by the power generation time and the average output of the both fuel cells as shown in Table 2. That is, in Comparative example 2, temperature of the fuel cell was excessively increased by power generation, the ion conductivity of the electrolyte membrane was lowered, and the cell resistance was increased. Under the influence thereof, power generation became unstable, and power generation time became short. Further, the average output became low. On the other hand, in Example, as a result of sufficient water retention in the fuel cell 1A by the heat insulating layer 40 and the water retaining layer 42, the cell resistance showed relatively a low value, and power generation was stabilized. Thereby, power generation was able to be made for a longer time at a higher output than in Comparative example 2.

That is, it was found that by providing the heat insulating layer 40 outside the oxidant-electrode-side package member 22, and forming the water retaining layer 42 in the through hole 41 of the heat insulating layer 40, power generation could be stabilized.

Further, when a comparison was made between Example and Comparative example 1, as evidenced by Table 1, in Example in which the polytetrafluoroethylene having high heat resistivity was used, the difference between the temperature A and the temperature B was large, temperature difference (temperature gradient) was generated in the thickness direction of the heat insulating layer 40, and more favorable results than those of Comparative example 1 were obtained for all of cell resistance, power generation time, and average output. On the other hand, in Comparative example 1 in which the aluminum (Al) plate having low heat resistivity was provided instead of the heat insulating layer 40, there was almost no difference between the temperature A and the temperature B. The reason thereof may be considered as follows. That is, in Example, since the temperature difference (temperature gradient) in the heat insulating layer 40 was generated, the water generated by power generation was returned into the fuel cell 1A, the water was retained in the fuel cell 1A, the cell resistance was decreased, and power generation was stabilized. As a result, long time power generation and high output were obtained. Meanwhile, in Comparative example 1, since the aluminum plate had the high conductivity, the temperature difference in the thickness direction was not formed, water retention function by the water retaining layer was not sufficiently obtained, and the cell resistance was higher than that of Example. Further, in Comparative example 1, power generation was unstable though not to the extent of Comparative example 2, and the power generation time and the average output were lower than those of Example.

That is, it was found that by not providing the aluminum plate having low heat resistivity but providing the heat insulating layer 40 having high heat resistivity, the temperature difference (temperature gradient) was generated in the thickness direction of the heat insulating layer 40, and stable power generation could be made.

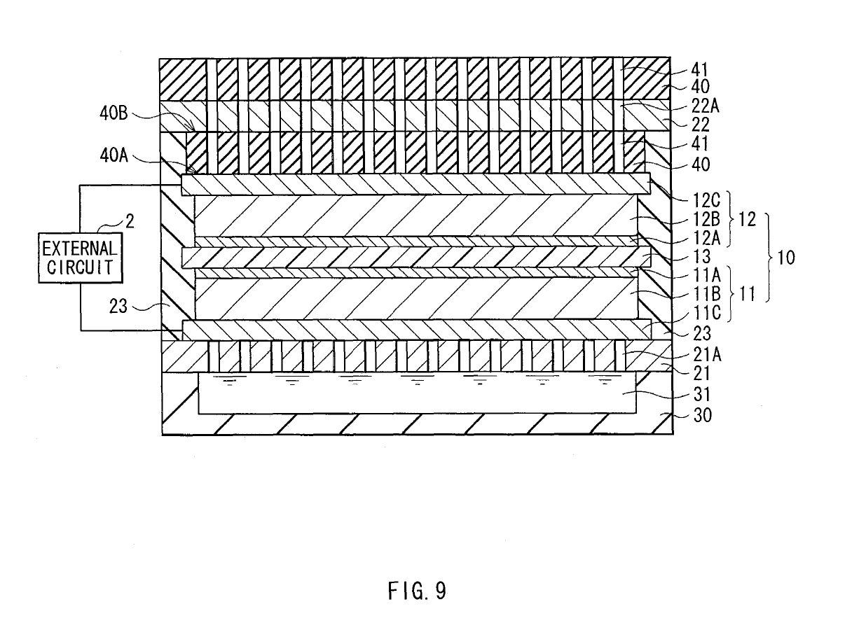

The present invention has been described with reference to the embodiments and the example. However, the present invention is not limited to the foregoing embodiments and the foregoing example, and various modifications may be made. For example, in the foregoing first and the second embodiments and the foregoing example, the description has been given of the case that the heat insulating layer 40 is provided in one of the location between the oxidant-electrode-side package member 22 and the oxidant electrode current collector 12C and the location outside the oxidant-electrode-side package member 22. However, the present invention includes all structures providing the heat insulating layer 40 or the oxidant-electrode-side package member 22 made of a material having heat insulating properties in a location on the oxidant electrode 12 side of the electrolyte membrane 13 and outside the oxidant electrode current collector 12C. For example, as illustrated in FIG. 9, the heat insulating layer 40 may be provided in both of the location between the oxidant-electrode-side package member 22 and the oxidant electrode current collector 12C and the location outside the oxidant-electrode-side package member 22.

Further, for example, in the foregoing embodiments and the foregoing example, the description has been given of the case that the water retaining layer 42 is provided in the through hole 41 of the heat insulating layer 40. However, the water retaining layer 42 may be provided in the through hole 22A of the oxidant-electrode-side package member 22.

Further, for example, it is possible that the heat insulating layer 40 described in the first and the second embodiments is provided, and the oxidant-electrode-side package member 22 is made of a material having heat insulating properties as described in the third embodiment. In this case, the water retaining layer 42 may be provided in the through hole 41 of the heat insulating layer 40, or in the through hole 22A of the oxidant-electrode-side package member 22.

In addition, for example, in the foregoing embodiments and the foregoing example, the description has been given specifically of the structure of the power generator 10, the fuel-electrode-side package member 21, the oxidant side package member 22, the side face package member 23, the fuel chamber 30, and the heat insulating layer 40. However, other structure or other material may be adopted. Further, for example, the material and the thickness of each component, or the power generation conditions of the fuel cell and the like are not limited to those described in the foregoing embodiments and the foregoing example. Other material, other thickness, or other power generation conditions may be adopted.

Furthermore, in the foregoing embodiments and the foregoing example, the fuel chamber 30 is a hermetically sealed type, and the fuel 31 is supplied according to needs. However, the fuel may be supplied from the fuel supply section (not illustrated) to the fuel electrode 11. Further, for example, the fuel 31 may be a liquid fuel such as ethanol and dimethyl ether other than methanol.

In addition, the present invention is also applicable to a fuel cell using a material such as hydrogen other than the liquid fuel as a fuel, in addition to the fuel cell using the liquid fuel.

Furthermore, in the foregoing embodiments and the foregoing example, the description has been given of the single cell type fuel cell. However, the present invention is also applicable to a fuel cell composed of a plurality of cells electrically connected.

In addition, in the foregoing embodiments and the foregoing example, the description has been given of the case that the present invention is applied to the fuel cell and the electronic device including the same. However, in addition to the fuel cell, the present invention is applicable to other electrochemical device such as a capacitor, a fuel sensor, and a display.

1-7. (canceled)

8. A fuel cell comprising a power generator in which a fuel electrode and an oxidant electrode are oppositely arranged with an electrolyte in between, between a fuel-electrode-side package member and an oxidant-electrode-side package member, wherein
a heat insulating layer is included in at least one of a location between the oxidant-electrode-side package member and the oxidant electrode and a location outside the oxidant-electrode-side package member.

9. The fuel cell according to claim 8, wherein the oxidant electrode has a current collector, and the heat insulating layer is provided between the oxidant-electrode-side package member and the current collector of the oxidant electrode.

10. The fuel cell according to claim 8, wherein the heat insulting layer has a through hole, and a water retaining layer is provided in the through hole.

11. A fuel cell comprising a power generator in which a fuel electrode and an oxidant electrode are oppositely arranged with an electrolyte in between, between a fuel-electrode-side package member and an oxidant-electrode-side package member, wherein the oxidant-electrode-side package member is made of a material having heat insulating properties.

12. The fuel cell according to claim 11, wherein the oxidant-electrode-side package member has a through hole, and a water retaining layer is provided in the through hole.

13. An electronic device comprising a fuel cell containing a power generator in which a fuel electrode and an oxidant electrode are oppositely arranged with an electrolyte in between, between a fuel-electrode-side package member and an oxidant-electrode-side package member, wherein
a heat insulating layer is included in at least one of a location between the oxidant-electrode-side package member and the oxidant electrode and a location outside the oxidant-electrode-side package member.

14. An electronic device comprising a fuel cell containing a power generator in which a fuel electrode and an oxidant electrode are oppositely arranged with an electrolyte in between, between a fuel-electrode-side package member and an oxidant-electrode-side package member, wherein
the oxidant-electrode-side package member is made of a material having heat insulating properties.
